(19) United States
(12) Patent Application Publication
(10) Pub. No.: US 2011/0190413 A1
(43) Pub. Date: Aug. 4, 2011

(54) PROCESS FOR PREPARING POLYESTERS, ESPECIALLY POLYESTER ALCOHOLS

(75) Inventors: Lionel Gehringer, Schaffhouse-pre-Seltz (FR); Elke Gütlich-Hauk, Lambsheim (DE); Horst Binder, Lampertheim (DE)

(73) Assignee: BASF SE, Ludwigshafen (DE)

(21) Appl. No.: 13/019,536

(22) Filed: Feb. 2, 2011

Related U.S. Application Data
(60) Provisional application No. 61/301,258, filed on Feb. 4, 2010.

(51) Int. Cl. C08J 3/28; C08G 18/42; C08G 63/12; C08G 63/78

(52) U.S. Cl. 522/165; 525/440.01; 528/272

(57) ABSTRACT

A process for preparing polyesters by catalytically reacting at least one polyfunctional carboxylic acid or derivative of a polyfunctional carboxylic acid with at least one polyfunctional alcohol.

The present invention relates to a process for preparing polyesters, especially polyester alcohols, with reduced color number, to polyesters, especially polyester alcohols, preparable by the process according to the invention, and to the use of the polyester alcohols prepared in accordance with the invention for preparing polyurethanes.

### BACKGROUND

The preparation of polyesters, especially polyester alcohols (PESOLs), and the use of such products in polyurethane chemistry have been known for some time and described many times. Usually, polyester alcohols are prepared by polycondensation reactions of polybasic carboxylic acids and/or carboxylic acid derivatives with polyhydric alcohols or polyols. Examples include Kunststoffhandbuch [Polymer Handbook], Volume VII, Polyurethane, Carl-Hanser-Verlag, Munich, 1st edition 1966, edited by Dr. R Vieweg and Dr. A. Nichtlen, and 2nd edition 1983, and the 3rd, revised edition 1993, edited by Dr. G. Oertel. It is also known that polyester alcohols can be prepared by polycondensation reactions of w-hydroxycarboxylic acid, or by ring-opening polymerization of cyclic esters, known as lactones.

It is also possible to process polyester wastes and especially polyethylene terephthalate (PET) or polybutylene terephthalate (PBT) wastes. For this purpose, a whole series of processes are known and have been described. Some processes are based on the conversion of the polyester to a diester of terephthalic acid, for example to dimethyl terephthalate. DE-A 1003714 and U.S. Pat. No. 5,051,528 describe such transesterifications using methanol and transesterification catalysts.

The use of these polyester alcohols, especially to prepare polyurethanes, also referred to hereinafter as PUR, especially flexible PUR foam, rigid PUR foam, rigid polyisocyanurate (PIR) foam, and other cellular or noncellular PUR materials, or polyurethane dispersions, requires a specific selection of the starting materials and of the polycondensation technology to be employed. For preparation of polyurethane, it is especially important that the polyester alcohols used have a low acid number (see Ullmann's Encyclopedia, Electronic Release, Wiley-VCH-Verlag GmbH, Weinheim, 2000 under the heading “polyesters”, paragraph 2.3 “Quality Specifications and Testing”). The acid number should be at a minimum since the terminal acid groups react with diisocyanates more slowly than terminal hydroxyl groups. Polyester alcohols with high acid numbers therefore lead to a lower degree of molecular weight increase during the reaction of polyester alcohols with isocyanates to give polyurethane.

A further problem in the case of use of polyester alcohols with high acid numbers for the polyurethane reaction is that, in the reaction of the numerous terminal acid groups with isocyanates, amide bond formation takes place with release of carbon dioxide. The gaseous carbon dioxide can then lead to undesired bubble formation. Furthermore, free carboxyl groups worsen the catalysis in the polyurethane reaction and also the stability of the polyurethanes prepared to hydrolysis.

A known polycondensation technology for preparing polyester alcohols is the use of polyfunctional aromatic and/or aliphatic carboxylic acids or anhydrides thereof and difunctional, trifunctional and/or higher-functionality alcohols, especially of glycols, which can be reacted with one another at temperatures of especially 150-280° C. under standard pressure and/or gentle vacuum in the presence of catalysts while withdrawing the water of reaction. The customary technology is described, for example, in DE-A-2904184 and consists in the addition of the reaction components at the start of synthesis with a suitable catalyst while simultaneously increasing the temperature and lowering the pressure. The temperatures and the reduced pressure are then altered further in the course of the synthesis. The polycondensation reactions can be performed either in the presence or in the absence of a solvent. Polyester alcohols are prepared on the industrial scale, generally with the aid of the vacuum melt process, of the blowing gas melt process or of the azeotropic process. Further details of these processes can be taken from the Kunstoff-Handbuch Polyurethane, edited by G. Oertel, 3rd ed. 1993, Carl-Hanser-Verlag, Ch. 3.1.2, especially Ch. 3.1.2.3. The acid number in particular of the polyester alcohols should, as already mentioned, be at a minimum when the polyester alcohols are to be used to prepare polyurethanes. In addition, the color number of the polyester alcohols should be at a minimum.

For many applications, especially in the case of use of polyesterols (PESOL) to prepare polyurethanes (PU), coloring of polyesters, especially polyesterols, is unwanted. The causes of too strong a color of PESOL may include inadequate quality of the monomers, the type of monomers or insufficient inertization of the polymerization reactor.

The use of natural raw materials is gaining growing significance in the polymer industry, since the starting materials are sometimes significantly less expensive and some are available in virtually unlimited amounts.

Natural raw materials refer more particularly to substances which are obtained by processing from plants, or parts of plants (or else animals). A characteristic feature of raw materials from renewable sources is a significant proportion of the carbon isotope ¹⁴C. By means of determination thereof, it is possible to experimentally determine the proportion of renewable raw materials. Renewable raw materials differ from substances obtained by chemical synthesis or by mineral oil processing in that they are less homogeneous—the composition thereof can vary to a much greater degree. These variations in the composition of natural raw materials and the presence of further accompanying substances which are difficult to remove, such as degradation products or impurities, frequently lead, however, to problems in the later processing and therefore restrict the industrial benefit of these substances.

Variations in the composition of natural raw materials are, for example, dependent on factors such as climate and region in which the plant grows, the season of harvest, variations between biological species and subspecies, and the type of extraction process used (extrusion, centrifuging, filtering, distillation, cutting, pressing, etc.).

The preparation of polyester polyols by reaction of reactants obtained from natural raw materials is of great interest especially for the preparation of polyurethanes, for example for the shoe industry. Owing to the impurities and/or degradation products that reactants from natural raw materials may comprise, polyester polyols thus prepared, however, have found no industrial scale use to date. One reason for this is the strong color, which results from the impurities, of the polyester polyols obtained and/or faults in the functionality. This strong color ensures that an industrially viable conversion of these polyester polyols to polyurethanes is impossible. The products are often so dark that they cannot be used for visually demanding applications. Frequently, technical liquids such as liquid polyester polyols have unwanted yellowness, caused in some cases by impurities or degradation products.

Technical liquids can be classified in terms of color by the APHA/Hazen color assessment. The recommendation of this process by the American Public Health Organisation (APHA) led to the corresponding designation.

The principle of this color assessment is based on comparing the analysis samples visually in standardized vessels with yellow standard solutions of graduated concentrations. For the APHA/Hazen color number, after a proposal from A. Hazen from 1892, an acidic solution of potassium hexachloroplatinate(IV) and cobalt(II) chloride is used. A color number corresponding to the platinum content thereof in mg/l (the range is 0-600) is then assigned to the comparative solutions.

In the attempts to date to avoid excessive color of PESOL, additives have been used. For example, U.S. Pat. No. 4,897,474 uses a color improver such as hypophosphite and bleaches such as hydrogen peroxide to improve the color of a carbohydrate fatty acid ester polyol.

In U.S. Pat. No. 3,668,092, UV light is likewise used in the presence of an additive, for example hydrogen peroxide or peracetic acid, to improve the color of organic carboxylic esters or epoxy compounds.

JP 11-171986 is concerned with the preparation of polybutylene adipate from dimethyl adipate and 1,4-butanediol with UV irradiation.

JP 43020268 is concerned with polyethylene terephthalate fibers which, after esterification of terephthalic acid and ethylene glycol, are irradiated with light in the range of 3500-4500 A.

However, the processes provided to date are not based on raw materials of actually unsuitable quality and/or on natural raw materials which lead to light-colored polyester polyols without further purification, which are then suitable for a conversion to polyurethanes which meet the specifications for an upper color limit, among others.

Since the abovementioned additives, such as hydrogen peroxide, are not free of risks and disadvantages, an additionally advantageous process for improving the color of polyesters, especially PESOLs, would be one which does not need any of the abovementioned additions.

### DESCRIPTION OF THE INVENTION

It has now been found that, surprisingly, a distinct reduction in the color number of polyesters, especially PESOLs, can be achieved solely through irradiation of the polyesters, especially PESOLs, of the reaction mixture composed of at least one dicarboxylic acid (or derivatives thereof) and at least one polyol or polyfunctional alcohol and/or of the monomeric reactants with light of wavelength in the range from 100 nm to 600 nm, preferably from 200 to 600 nm.

The invention therefore provides a process for preparing polyesters, such as polyester alcohols in particular, by catalytically reacting at least one polyfunctional carboxylic acid or derivative of a polyfunctional carboxylic acid with at least one polyfunctional alcohol, which comprises treating the molten monomers before the reaction with light of wavelength in the range of 100 nm to 600 nm, preferably from 200 to 600 nm, and/or performing at least part of the reaction in the presence of light of wavelength in the range from 100 nm to 600 nm, preferably from 200 to 600 nm, and/or treating the polyester alcohol obtainable by the catalytic reaction, after the reaction, with light of wavelength in the range from 100 nm to 600 nm, preferably from 200 to 600 nm.

The process according to the invention can also be used to prepare polyesters as binders and thermoplastic compositions for coating materials and adhesives. However, it is also possible to produce biodegradable thermoplastic polyesters by the process according to the invention.

The process according to the invention gives a means of improving the color and hence the quality of the polyester alcohols which are obtained from the abovementioned standard processes for preparing polyester alcohols from dicarboxylic acids and polyols, by irradiation with light of wavelength in the range from 100 nm to 600 nm, preferably from 200 to 600 nm.

In one embodiment of the process according to the invention, the polyester alcohol obtained from the above-described process is decolorized in the presence of light of wavelength in the range from 100 nm to 600 nm, preferably from 200 to 600 nm.

In a further embodiment of the process according to the invention, the irradiation with light of wavelength in the range from 100 nm to 600 nm, preferably from 200 to 600 nm, is undertaken during the polymerization of at least one dicarboxylic acid (or derivatives thereof) and of at least one polyol.

In a further embodiment of the process according to the invention, the molten monomers (dicarboxylic acid(s) or derivatives thereof and polyol(s)) are treated before the polymerization with light of wavelength in the range from 100 nm to 600 nm, preferably from 200 to 600 nm. This embodiment of the process can be used, for example, for lactones, especially c-caprolactone, as the reactant.

It is also possible to combine more than one method of irradiation with light of wavelength in the range from 100 nm to 600 nm, preferably from 200 to 600 nm, or to combine all three forms of irradiation with light of wavelength in the range from 100 nm to 600 nm, preferably from 200 to 600 nm, with one another.

For example, it is possible to treat the molten monomers (dicarboxylic acid(s) or derivatives thereof and polyol(s)) before the polymerization with light of wavelength in the range from 100 nm to 600 nm, preferably from 200 to 600 nm, and then additionally to undertake irradiation with light of wavelength in the range from 100 nm to 600 nm, preferably from 200 to 600 nm, during the polymerization of at least one dicarboxylic acid (or derivatives thereof) and of at least one polyol (or polyfunctional alcohol). It is likewise possible to undertake irradiation with light of wavelength in the range from 100 nm to 600 nm, preferably from 200 to 600 nm, during the polymerization of at least one dicarboxylic acid (or derivatives thereof) and of at least one polyol (or polyfunctional alcohol), and then to decolorize the polyester alcohol obtained from the above-described process even further in the presence of light of wavelength in the range from 100 nm to 600 nm, preferably from 200 to 600 nm.

In the process according to the invention, the monomers, the reaction mixture and/or the PESOL is irradiated with light of wavelength from 100 to 600 nm, preferably from 200 to 600 nm, more preferably 220 to 500 nm, especially preferably 220 to 450 nm and most preferably 220 to 420 nm.

In one embodiment, UV light is used for irradiation. The UV range extends from about 100 nm to about 400 nm.

Suitable radiation sources are in principle all of those which emit light of wavelength from 100 to 600 nm, preferably from 200 nm to 600 nm. Also suitable are all UV sources which emit electromagnetic radiation in the UV-A, UV-B and/or UV-C range.

The radiation source used should preferably have at least one emission maximum in the wavelength range from 100 to 600 nm.

The energy dose is sufficient when the desired color numbers are attained or when no further color reduction is achieved by further irradiation. There is in principle no upper limit in the energy dose. Very high doses could possibly result in unwanted side reactions or decompositions, but a corresponding maximum dose can be determined easily by a person skilled in the art in the individual case.

Suitable radiation sources are, for example, low-pressure, moderate-pressure or high-pressure mercury radiators, which may be undoped or gallium- or iron-doped, and also fluorescent tubes, pulsed radiators, metal halide radiators, excimer radiators, lasers, LEDs, pulsed lamps (flashlights) or halogen lamps.

Preference is given to moderate-pressure mercury lamps with doping, especially with iron doping. Likewise preferred are UV LEDs.

It will be appreciated that it is also possible to use a plurality of identical or different radiation sources to achieve the desired energy dose or spectral distribution. These may also emit in different wavelength ranges in each case.

It is also possible, by means of suitable optical filters, to mask specific wavelength ranges out of the irradiation spectrum to avoid unwanted photo reactions.

In the embodiment of the process according to the invention with irradiation after the reaction, the temperature of the PESOL in the course of irradiation is only of minor importance. The lower temperature limit is fixed by the fact that the PESOL should be pumpable; the upper limit is fixed by the thermal stability thereof. The temperature is preferably from ambient temperature to 240° C., more preferably from 60° C. to 180° C., and especially from 80° C. to 160° C.

In the case of irradiation of the monomeric reactants before the reaction, the temperature is preferably 80° C. to 120° C. If the irradiation of the reactants is performed during the reaction with light of wavelength in the range from 100 nm to 600 nm, preferably from 200 to 600 nm, this is done at the customary reaction temperature in the range from 150° C. to 280° C., preferably in the range from 150° C. to 260° C.

The polyester alcohols prepared by the process according to the invention have, according to the desired end use, a hydroxyl number in the range between 20 and 400 mg KOH/g. The hydroxyl number of polyester alcohols which are used for the production of flexible polyurethane foams or thermoplastic polyurethane elastomers is preferably in the range between 20 and 250 mg KOH/g. Polyester alcohols for use in rigid polyurethane foams preferably have a hydroxyl number of more than 100 mg KOH/g, especially between 100 and 400 mg KOH/g.

The polyfunctional carboxylic acids or derivatives are preferably selected from the group consisting of succinic acid, glutaric acid, adipic acid, suberic acid, azelaic acid, sebacic acid, decanedicarboxylic acid, maleic acid, fumaric acid, phthalic acid, isophthalic acid, terephthalic acid, dicarboxylic esters of alcohols having 1 to 4 carbon atoms, dicarboxylic anhydrides or dicarboxylic acid mixtures of succinic acid, glutaric acid and adipic acid, or fatty acid or fatty acid derivatives from the group consisting of castor oil, polyhydroxy fatty acids, ricinoleic acid, hydroxyl-modified oils, grapeseed oil, black cumin oil, pumpkin seed oil, borage seed oil, soybean oil, wheatgerm oil, rapeseed oil, sunflower oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, hydroxyl-modified fatty acids and fatty acid esters based on myristoleic acid, palmitoleic acid, oleic acid, vaccinic acid, petroselic acid, gadoleic acid, erucic acid, nervonic acid, linoleic acid, α- and γ-linolenic acid, stearidonic acid, arachidonic acid, timnodonic acid, clupanodonic acid and cervonic acid.

Suitable polyhydroxyl compounds are all at least dihydric alcohols, but preferably diol components, for example ethylene glycol, diethylene glycol, 1,3-propanediol, 1,2-propanediol, dipropylene glycol, 1,4-butanediol, 1,5-pentanediol, 1,6-hexanediol, 1,10-decanediol, neopentyl glycol, 2-methyl-1,3-propanediol, 3-methyl-1,5-pentanediol. To increase the functionality of the polyester alcohols, it is also possible to use trifunctional or higher-functionality alcohols. Examples thereof are glycerol, trimethylolpropane and pentaerythritol, sorbitol and sucrose. It is also possible to use oligomeric or polymeric products with at least two hydroxyl groups. Examples thereof are polytetrahydrofuran, polylactones, polyglycerol, polyetherols, polyesterol or α,ω-dihydroxypolybutadiene.

The process according to the invention is particularly suitable when using bio-based and/or renewable raw materials (natural raw materials), for example when using a dicarboxylic acid selected from the group consisting of sebacic acid, azelaic acid, dodecanedioic acid, succinic acid and 2-methylsuccinic acid, and polyhydric alcohols selected from the group consisting of 1,3-propanediol, 1,2-ethanediol and butanediols (especially 1,4-butanediol).

These and further bio-based raw materials are generally more highly colored than comparable conventional raw materials. The process according to the invention is therefore an option particularly since the irradiation with light of wavelength from 100 nm to 600 nm, preferably from 200 to 600 nm, before, during and/or after the reaction can reduce the color number of the resulting polyesterol and hence, in spite of a strong color of the reactants, can shift it into an acceptable or even good range.

To prepare the polyesterpolyols, the organic polycarboxylic acids and/or derivatives and polyhydric alcohols are preferably polycondensed in a molar ratio of 1:(1 to 2.1), more preferably of 1:(1.05 to 1.9). The functionality of the polyester alcohols prepared is, depending on the raw materials used, preferably in the range from at least 1.9 to 4.0, more preferably in the range from 2.0 to 3.0.

The number-average molecular weight of the polyester alcohols prepared is preferably in the range from 200 g/mol to 10 000 g/mol, more preferably in the range of 500-5000 g/mol.

The acid numbers of the polyester alcohols prepared are preferably in the range of less than 10 g KOH/kg, more preferably in the range of less than 5 g KOH/kg, most preferably in the range of less than 2 g KOH/kg. The acid number serves to determine the content in the polyesterol of free organic acids. The acid number is determined by the number of mg of KOH (or g of KOH) which is needed to neutralize 1 g (or 1 kg) of the sample.

The catalytic reaction is preferably performed in the presence of an esterification catalyst.

The esterification catalyst is preferably selected from the group comprising toluenesulfonic acids and organometallic compounds.

The organometallic compounds are preferably selected from compounds based on titanium or tin, more preferably from the group comprising the organometallic compounds titanium tetrabutoxide or tin(II) octoate, dibutyltin laurate and/or tin chloride.

According to the invention, the irradiation can be effected continuously or batchwise. The PESOL may be at rest or preferably in motion, for example by pumped circulation or stirring.

It is also possible that the irradiation is effected in an apparatus during the preparation, by, for example, placing a lamp into the reaction vessel, or that the monomeric reactants are irradiated before the esterification.

The color number of the polyester alcohol obtained is typically 150 APHA/Hazen, preferably not more than 100 APHA/Hazen, more preferably not more than 50 APHA/Hazen.

If the irradiation with light of wavelength from 100 nm to 600 nm, preferably from 200 to 600 nm, is effected on the polyester alcohol obtained after the catalytic reaction, a reduction in the color number of the polyester alcohol before the irradiation compared to the color number of the polyester alcohol after the irradiation by at least 1%, preferably by at least 5%, more preferably by at least 20%, most preferably by at least 50%, can generally be achieved.

Even in the case of irradiation of the monomeric reactants before the catalytic reaction and in the case of irradiation during the catalytic reaction, it is generally possible to achieve a reduction in the color number of the resulting polyester alcohol compared to the color number of the polyester alcohol obtained by an otherwise identical process but without irradiation by at least 1%, preferably by at least 5%, more preferably by at least 20%, most preferably by at least 50%.

The percentage reduction in the color number of the polyester alcohol before the irradiation depends on several factors.

For example, the purity of the monomers used is important; in general, in the case of monomers of low purity (and thus generally of high color), with otherwise the same process conditions, a particularly high percentage reduction in the color number in the end product can be achieved.

In general, a longer irradiation time also results in a higher percentage reduction in the color number of the end product compared to the polyester alcohols before the irradiation with light of wavelength from 100 nm to 600 nm, preferably from 200 to 600 nm.

The temperature during the process and the type of radiation source may likewise have an influence; irrespective of the factors mentioned, it is, however, always possible by the process according to the invention to achieve a significant improvement in the color (reduction in the color number).

In one embodiment of the invention, no further additives are used aside from at least one polyfunctional carboxylic acid or derivative thereof, at least one polyfunctional alcohol and at least one esterification catalyst.

The process according to the invention thus gives numerous advantages over the processes described to date for improving the color of PESOLs.

Firstly, the process according to the invention can ensure a homogeneous color and hence homogeneous quality. Secondly, it is possible to dispense with the addition of bleaches or color improvers, which both simplifies the workup of the products and is desirable for cost and environmental reasons. Moreover, many of the additives used in processes described to date lead to a deterioration in the quality of the PESOL.

Furthermore, the process according to the invention allows variation in the quality of the monomers without noticeable quality losses in the products (PESOL). It is thus possible to use, for example, starting materials from biological raw materials (renewable raw materials), without adversely affecting the quality of the products.

In addition, it is possible with the aid of the process according to the invention to open up new markets, by providing polyols of better quality. One example which can be mentioned here is the preparation of colorless PESOL from fatty acid derivatives.

The invention further provides a process for preparing a polyurethane by reacting a polyester polyol prepared (or preparable) by the process according to the invention with one or more organic diisocyanates (or polyisocyanates).

The polyurethane which is obtained from a polyester polyol prepared by the process according to the invention is especially a thermoplastic polyurethane. Thermoplastic polyurethanes are also referred to hereinafter as TPU.

The polyurethanes can in principle be prepared by the known processes, batchwise or continuously, for example with reaction extruders or the belt process, by the “one-shot” process or the prepolymer process (including multistage prepolymer processes as in U.S. Pat. No. 6,790,916B2), preferably by the “one-shot” process. In these processes, the components being reacted, polyesterol, chain extender, isocyanate (see table 1) and optionally auxiliaries and additives (especially UV stabilizers), can be mixed with one another successively or simultaneously, and the reaction sets in immediately.

Further details of the abovementioned auxiliaries and additives can be found in the specialist literature, for example in “Plastics Additive Handbook”, 5th Edition, H. Zweifel, ed, Hanser Publishers, Munich, 2001, H. Saunders and K. C. Frisch “High Polymers”, Volume XVI, Polyurethane, Parts 1 and 2, Verlag Interscience Publishers 1962 and 1964, Taschenbuch für Kunststoff-Additive [Handbook of plastics additives] by R. Gachter and H. Muller (Hanser Verlag Munich 1990) or DE-A 29 01 774.

Apparatus for preparing polyurethanes is known to those skilled in the art; see, for example, Kunststoffhandbuch, Volume VII, Polyurethane, Carl-Hanser-Verlag, Munich, 1st Edition 1966, edited by Dr. R Vieweg and Dr. A. Hochtlen, and 2nd Edition 1983, and the 3rd revised edition 1993, edited by Dr. G. Oertel.

The present invention further provides for the use of a polyester polyol prepared by the process according to the invention for producing polyurethanes (also referred to hereinafter as PUR), especially flexible PUR foam, rigid PUR foam, rigid polyisocyanurate (PIR) foam, and also other cellular and noncellular PUR materials or polyurethane dispersions. The polyurethanes as described above can be used, inter alia, to produce mattresses, shoe soles, seals, pipes, floors, profiles, coating materials, adhesives, sealants, skis, automobile seats, running tracks in stadia, instrument panels, various moldings, potting compositions, films, fibers, nonwovens and/or cast floors.

The invention further relates to the use of polyester polyols for preparing polyurethanes, to the preparation of (foamed) flexible foam or compact cast systems.

The present invention further provides for the use of a thermoplastic polyurethane prepared by the process according to the invention for producing moldings, pipes, films and/or fibers.

The present invention further provides a molding, a film, a pipe or a fiber produced from a thermoplastic polyurethane based on the process according to the invention.

### DESCRIPTION OF THE FIGURES

FIG. 1 shows, by way of example, the spectrum of a Hönle exposure device which can be used as a radiation source in the process according to the invention.

FIG. 2 shows an illustrative spectrum of a UV LED which can be used as a radiation source in the process according to the invention.

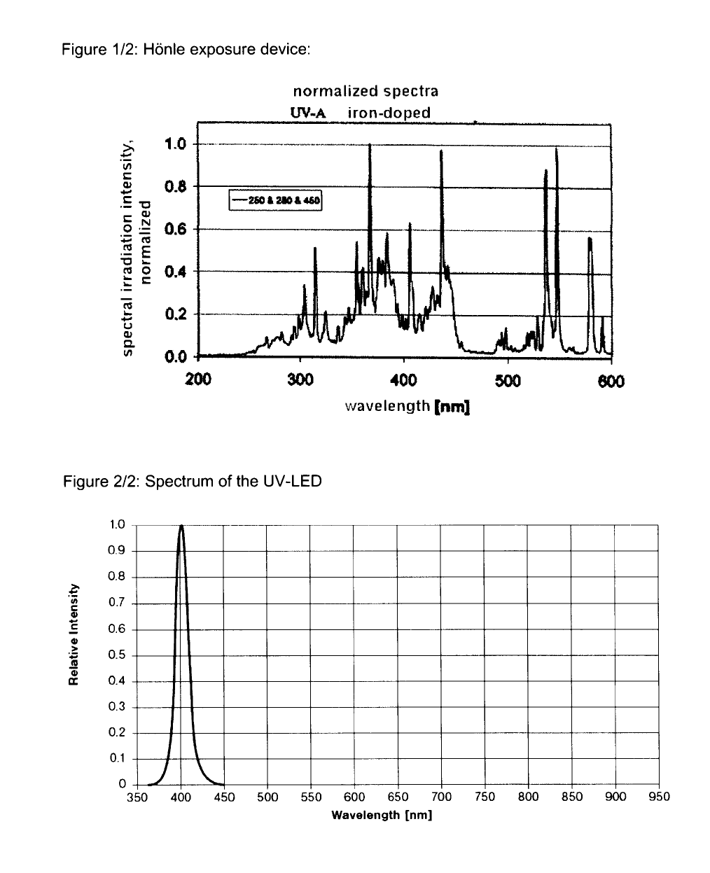

### EXAMPLES

Some examples will be described hereinafter to illustrate the invention. In no way are these examples intended to restrict the scope of protection of the present invention; they should be understood merely in an illustrative sense.

### Example 1

### Preparation of Conventional PESOL A

6040.1 g of adipic acid, 1406.8 g of ethylene glycol, 2042.6 g of butanediol-1,4, 1 ppm of titanium tetrabutoxide and 5 ppm of tin octoate were charged into a round-bottom flask with a capacity of 12 liters. The mixture was heated to 180° C. while stirring and left at this temperature for 3 hours. In the course of this, the water formed was removed by distillation.

Thereafter, the mixture was heated to 240° C. and left at this temperature under a vacuum of 40 mbar until an acid number less than 1 mg KOH/g had been attained.

The liquid polyester alcohol A formed had the following characteristics:

Hydroxyl number: 58.5 mg KOH/g
Acid number: 0.40 mg KOH/g
Viscosity: 570 mPa·s at 75° C.
Color number: 51 APHA/Hazen

### Irradiation

The polyester polyols A obtained were subjected to irradiation with light of wavelength from 200 to 600 nm for 12 hours, and the resulting polyester polyol exhibited a color index of 10 APHA/Hazen.

For the irradiation, a 400 W moderate-pressure mercury lamp with iron doping was used. During the irradiation, the temperature of the polyester polyol rose to approx. 80° C.

### Example 2

### Synthesis of PESOL B from Low-Quality Ethylene Glycol

6040.1 g of adipic acid, 1406.8 g of ethylene glycol (low quality, corresponding to a purity of ≦99.5%), 2042.6 g of butanediol-1,4 (low quality, corresponding to a purity of ≦99.5%), 1 ppm of titanium tetrabutoxide and 5 ppm of tin octoate were charged into a round-bottom flask with a capacity of 12 liters. The mixture was heated to 180° C. while stirring and left at this temperature for 3 hours. In the course of this, the water formed was removed by distillation.

Thereafter, the mixture was heated to 240° C. and left at this temperature under a vacuum of 40 mbar until an acid number less than 1 mg KOH/g had been attained.

The liquid polyester alcohol B formed had the following characteristics:

Hydroxyl number: 56 mg KOH/g
Acid number: 0.1 mg KOH/g
Viscosity: 620 mPa·s at 75° C.
Color number: 480 APHA/Hazen

### Irradiation

The polyester polyols B obtained were subjected to irradiation with light of wavelength from 200 to 600 nm for 14 hours, and the resulting polyester polyol exhibited a color index of 110 APHA/Hazen.

For the irradiation, a Hönle UV 400 F/2 400 W moderate-pressure mercury lamp was used. During the irradiation, the temperature of the polyester polyol rose to approx. 80° C.

In addition, a UV LED from Perkin Elmer was used.

The energy measuring unit used was a UV meter (probe No. 724 (UV-A range)) from Hönle.

The spectra of the irradiation sources can be found in the figures.

### Example 3

A PESOL A prepared according to example 1 with a color number of 51 Hz was irradiated with a UV LED with a peak wavelength of 403 nm from Perkin Elmer at a temperature of approx. 30° C. for 7 h.

After the irradiation, the color number had improved. A color number of 35 Hz was measured.

### Example 4

### Preparation of Conventional PESOL C

1940.9 g of adipic acid, 601.2 g of ethylene glycol, 436.5 g of butanediol-1,4, 1 ppm of titanium tetrabutoxide and 1 ppm of tin octoate were charged into a round-bottom flask with a volume of 4 liters. The mixture was heated to 180° C. while stirring and left at this temperature for 3 hours. In the course of this, the water formed was removed by distillation.

Thereafter, the mixture was heated to 240° C. and left at this temperature under a vacuum of 40 mbar until an acid number less than 1 mg KOH/g had been attained.

The liquid polyester alcohol C formed had the following characteristics:

Hydroxyl number: 56.6 mg KOH/g
Acid number: 0.60 mg KOH/g
Viscosity: 610 mPa·s at 75° C.
Color number: 77 APHA/Hazen
Treatment with UV Light A

The polyester polyols C obtained were exposed to UV irradiation for 3 hours, and the resulting polyester polyol exhibited a color index of 43 hazen.

For the irradiation, a Panacol ES450 400 W moderate-pressure mercury lamp was used. During the irradiation with UV light, the temperature of the polyester polyol rose to approx. 80° C.

In a further test series, the polyester polyol was irradiated for longer periods. This achieved the following results:

| after 0 h | after 3 h | after 6 h | after 13 h | after 20 h | after 27 h |
|---|---|---|---|---|---|
| 77 Hz | 43 Hz | 37 Hz | 31 Hz | 25 Hz | 19 Hz |

Treatment with UV Light B

The polyester polyols C obtained were exposed to UV irradiation for 3 hours, and the resulting polyester polyol exhibited a color index of 50 hazen.

For the irradiation, a Panacol ES460 400 W moderate-pressure mercury lamp was used. During the irradiation with UV light, the temperature of the polyester polyol rose to approx. 80° C.

Treatment with UV Light C

The polyester polyols C obtained were exposed to UV irradiation for 3 hours, and the resulting polyester polyol exhibited a color index of 50 hazen.

For the irradiation, a Panacol ES470 400 W moderate-pressure mercury lamp was used. During the irradiation with UV light, the temperature of the polyester polyol rose to approx. 80° C.

1. A process for preparing polyesters by catalytically reacting at least one polyfunctional carboxylic acid or derivative of a polyfunctional carboxylic acid with at least one polyfunctional alcohol, which comprises treating the molten monomers before the reaction with light of wavelength from 100 nm to 600 nm, preferably from 200 nm to 600 nm, and/or performing at least part of the reaction in the presence of radiation with light of wavelength from 100 nm to 600 nm, preferably from 200 to 600 nm, and/or treating the polyester obtainable by the catalytic reaction, after the reaction, with light of wavelength from 100 nm to 600 nm, preferably from 200 to 600 nm.

2. The process according to claim 1, wherein the polyester is selected from the group of the polyester alcohols.

3. The process according to claim 1 or 2, wherein the molten monomers are treated before the reaction with light of wavelength from 100 nm to 600 nm, preferably from 200 to 600 nm.

4. The process according to claim 1 or 2, wherein at least part of the reaction is performed in the presence of light of wavelength from 100 nm to 600 nm, preferably from 200 to 600 nm.

5. The process according to claim 4, wherein the entire reaction is performed in the presence of light of wavelength from 100 nm to 600 nm, preferably from 200 to 600 nm.

6. The process according to claim 1 or 2, wherein the polyester alcohol obtainable by the catalytic reaction is treated after the reaction with light of wavelength from 100 nm to 600 nm, preferably from 200 to 600 nm.

7. The process according to any of claims 2 to 6, wherein the color number of the polyester alcohol obtained is not more than 150 APHA/Hazen, preferably not more than 100 APHA/Hazen, more preferably not more than 50 APHA/Hazen.

8. The process according to any of claims 2 or 6 to 7, wherein a reduction in the color number of the polyester alcohol before the irradiation compared to the color number of the polyester alcohol after the irradiation by at least 5%, preferably by at least 20%, more preferably by at least 50%, is achieved.

9. The process according to any of the preceding claims, wherein the total duration of the irradiation with light of wavelength from 100 nm to 600 nm, preferably from 200 to 600 nm, is 0.1 to 25 hours, preferably 0.1 to 15 hours, more preferably 0.1 to 5 hours.

10. The process according to any of the preceding claims, wherein the at least one polyfunctional carboxylic acid or derivative of a polyfunctional carboxylic acid used and/or the at least one polyfunctional alcohol used is from the group of the natural raw materials.

11. The use of light of wavelength from 100 nm to 600 nm, preferably from 200 to 600 nm, for preparing polyester alcohols with reduced color number.

12. A polyester alcohol preparable according to any of claims 2 to 11.

13. The use of polyester alcohols according to claim 12 for preparing polyurethanes.
